(19) United States
(12) Patent Application Publication
(10) Pub. No.: US 2009/0199083 A1
(43) Pub. Date: Aug. 6, 2009

(54) Method of enabling the modification and annotation of a webpage from a web browser

(76) Inventors: Can Sar, Stanford, CA (US); Jesse Young, Belmont, CA (US); Tristan Harris, San Francisco, CA (US)

Correspondence Address: PILLSBURY WINTHROP SHAW PITTMAN LLP, P.O. BOX 10500, MCLEAN, VA, 22102, US

(21) Appl. No.: 12/321,597

(22) Filed: Jan. 21, 2009

Related U.S. Application Data
(60) Provisional application No. 61/021,893, filed on Jan. 17, 2008.

(51) Int. Cl. G06F 17/25

(52) U.S. Cl. 715/231

(57) ABSTRACT

The present invention relates to enabling the modification and annotation of any webpage from a web browser by any user (with appropriate privileges) without the need for custom plugins or browser extensions.

This application is related to and claims priority from U.S. Appln. No. 61/021,893 filed Jan. 17, 2008, and entitled “Method of Enabling the Modification and Annotation of a Webpage From a Web Browser,” the contents of which are expressly incorporated by reference herein.

### FIELD OF THE INVENTION

The present invention relates to enabling the modification and annotation of any webpage from a web browser by any user (with appropriate privileges) without the need for custom plugins or browser extensions.

### BACKGROUND OF THE INVENTION

Several other services automatically change the appearance of a page by adding links to certain key phrases on the site.

Integration with CMS

There are a number of services (e.g. Inform) that automatically insert HTML links into a document by directly modifying that document on the publisher side, either by updating the stored version of a document or by interfacing with the publishers web serving system and inserting the changes before they are sent to the user's web browser. Our solution is fundamentally distinct from this because all changes are made without modifying the original copy and without requiring any integration with the publishing system. Our system also allows anyone who visits a page to edit it (though this access can be restricted to only properly authenticated users), effectively turning any HTML page into a Wiki.

### JavaScript

The JavaScript solutions can be divided into three rough categories: programs that automatically turn certain keywords into links, those that automatically modify existing links on the page, and those that add additional content to the page at the exact location where the page author has inserted a line of HTML pointing to the JavaScript file (or including embedded JavaScript Code) for the particular service.

Solutions in the first category have a list of key phrases on a page that they want to turn into a link. When the page is loaded this list is fetched and occurrences of these keywords are turned into links. Some of these simply have a predetermined list of phrases to modify on every page while others preload individual pages, analyze their content, and then determine which words to use.

Solutions in the second category simply go through the existing links on a page and modify them (or a subset of them) to behave differently. An example of this are Snap Preview Popups that add a JavaScript MouseOver handler to existing links. By default all links on page are modified in this fashion but users can customize this to only apply to links to other domains, a section of the page (by placing it inside a special div), or links that are specially marked by a certain HTML link class.

Solutions in the third category are able to apply far greater modifications to the page such as inserting a comment field or message board but are limited to applying this change only in the location where the author placed the corresponding line of JavaScript. The method of achieving this is relatively simple: the author embeds a line of HTML pointing to a JavaScript file which then gets loaded in the browser when a user visits a page at the position in the DOM (the browser's Document Object Model) where the line of HTML was placed. The browser then executes its code that will create something e.g. a comment field at that location. This works the same way as if the author had embedded the JavaScript directly at that location on the page—the created content is tied to its particular location and can only be embedded there.

### Browser Plugins

There are a number of solutions, which let users place annotations onto pages using custom plugins for web browsers. These programs are generally browser specific so that a different version has to be written for each browser (Internet Explorer, Firefox, etc.) and sometimes also for each Operating System (Windows, Mac OS, Linux, etc.). Furthermore, web page visitors have to download these plugins onto their computers and install them which is often complicated and requires the user to trust the security of the software they are downloading. Furthermore, annotations created by a user can only be seen by other users who have downloaded the plugin. This is impractical for most website authors as the majority of visitors are unlikely to have installed this plugin already.

### Mirrored Pages

In this solution the user is redirected from the URL of the page they want to edit to a copy of that page on the solution providers URL through some mechanism (e.g. http://www.cnn.com/ would become http://www.solution.com/mirror.php?url=http://www.cnn.com/). The solution provider uses a web server that loads the page from its original URL, modifies it in some way, often by adding JavaScript to it, and then displays it to the user. This is often used by providers of Browser Plugin solutions so that users who do not have the plugin installed can see annotations created by someone else by being receiving a link to a special mirrored URL from this person. Sometimes people can even create annotations without use of a plugin on the mirrored URL itself. The main problem is that annotations can only be seen by people who visit this special URL—not the original page.

### SUMMARY

The present invention relates to enabling the modification and annotation of any webpage from a web browser by any user (with appropriate privileges) without the need for custom plugins or browser extensions.

In one aspect there is described A method of storing annotations for a web page that contains a script therein, which annotations in use are merged with the web page to present an annotated web page on a computer display, the method comprising the steps of: receiving at an annotation server, at least one annotation for the web page, the annotation including content and a location of the content within the web page, wherein the content identifies a change to render to the web page to obtain the annotated web page and wherein the location is independent of a placement location of the script within the web page; storing the at least one annotation in a memory location of the annotation server, the at least one annotation including reference to the web page; receiving, at the annotation server, a request for the annotation based upon the script stored within the webpage; and automatically transmitting, from the memory location, in response to the request, the annotation.

In another aspect, there is described a method of displaying on a display an annotated web page, the annotated web page created from merging a web page that contains a script therein with an annotation, the method comprising the steps of: receiving at a computer that includes a processor, a display memory, and executable software, the web page that contains the script therein; detecting, using the processor and the executable software, the script; transmitting, based upon the detected script, a request for the annotation; receiving the annotation at the computer, the annotation including content and a location of the content within the web page, wherein the content identifies a change to render to the web page to obtain the annotated web page and wherein the location is independent of and different from a placement location of the script within the web page; associating, using the processor and the application, the web page and the annotation to obtain the annotated webpage; and transmitting data of the annotated web page for displaying on the display.

### BRIEF DESCRIPTION OF THE DRAWINGS

These and other aspects and features of the present invention will become apparent to those of ordinary skill in the art upon review of the following description of specific embodiments of the invention in conjunction with the accompanying figures, wherein:

FIG. 1 illustrates a flowchart for viewing annotations according to an embodiment;

FIG. 2 illustrates a flowchart for identifying substantially identical web pages according to an embodiment; and

FIG. 3 illustrates a flowchart for updating annotations and/or links.

### DETAILED DESCRIPTION OF THE PREFERRED EMBODIMENTS

The Editing System described herein allows any visitor to a webpage that is using the system's web service to modify this webpage, given that they have the necessary access rights. The service can be installed on any HTML webpage by including one line of HTML that points to the system's Javascript (e.g. <script type=“text/javascript” src=“http://www.apture.com/js/apturejs?siteToken=xK4iwbVl2if Y”></script>). The service can be used together with an account management system in which case the page owner has to register for the service and create an account or allow anyone to edit the page in which case they do not even have to register. Any web user can then visit the page, login to the editing system and place annotations to the page, such as adding links to existing text, adding, modifying, or deleting text, adding images or other bits of HTML, etc. These annotations are then visible to any other visitor of the web page with a web browser that supports Javascript. The system may also be used to create rich annotations but for the purposes herein we will assume that an annotation can be any arbitrary HTML code.

### Annotation Storage Format

How to store the annotation position is a difficult question because our format must be compatible with at least 3 major browsers (Internet Explorer, Firefox, and Safari) and different versions of these as well as our backend code which can understand HTML markup but does not have the same complex rendering capabilities as a web browser. Our initial implementation used a DOM indexing strategy where we stored the list of nodes in the DOM tree that was traversed to get to the node after which we wanted to insert our annotations. As an example the location for an annotation for the word “some” in the HTML below would be represented as contentDiv.0.1[8:12], which the code would interpret as starting at the element with the id contentDiv, taking its 0^{th} child, then the 1^{st} child of that node, and then taking the 8^{th} through 12^{th} character of the text node (starting to count from 0).

<html>
<body>
<p>...</p>
<p>...</p>
<div id=‘contentDiv’>
<p>

<div>...</div>
<div>

Here is some text

</div>
....

</p>
</div>
</body>
</html>

While this strategy will work, on disadvantage is that different browsers render even correctly written pages differently and that the DOM trees that they generate look very different for some websites. We ameliorated this problem by ignoring empty textnodes (which some browsers spuriously generate) and certain other constructs but found that many pages will still render very differently (some browsers automatically add Table Body nodes which we can't always safely ignore).

After much experimentation we were able to identify the minimum unit of information that we would have to store that would make insertion of annotations into the page both efficient and cross browser compatible. Our solution is to anchor Annotations to particular nodes in the tree by storing some identifying characteristic of them (such as the class, id, source of an image node, and for some types even node name (e.g. ‘td’ or ‘tr’)) or part of the text of a textnode. We call this the annotation's “identifier”. In addition to this identifier we also store an integer indicating the number of times that identifier appears in the document content area prior to the position where the annotation is intended to be placed. This integer is also called the “occurrence index” of the identifier. For example, when an annotation is anchored to the third appearance of the text “White House” on a page the occurrence index will be 2 (since we start counting from 0). The index for an annotation of the second image of class “largelmage” would be 1. Since different types of annotation are treated differently we also store the type of annotation (e.g. Node Annotation, Text Annotation, Insertion Annotation). Text annotations simply modify the actual text phrase that is stored with them. Insertion Annotations insert a new node (or many nodes) after or before a node that we position into.

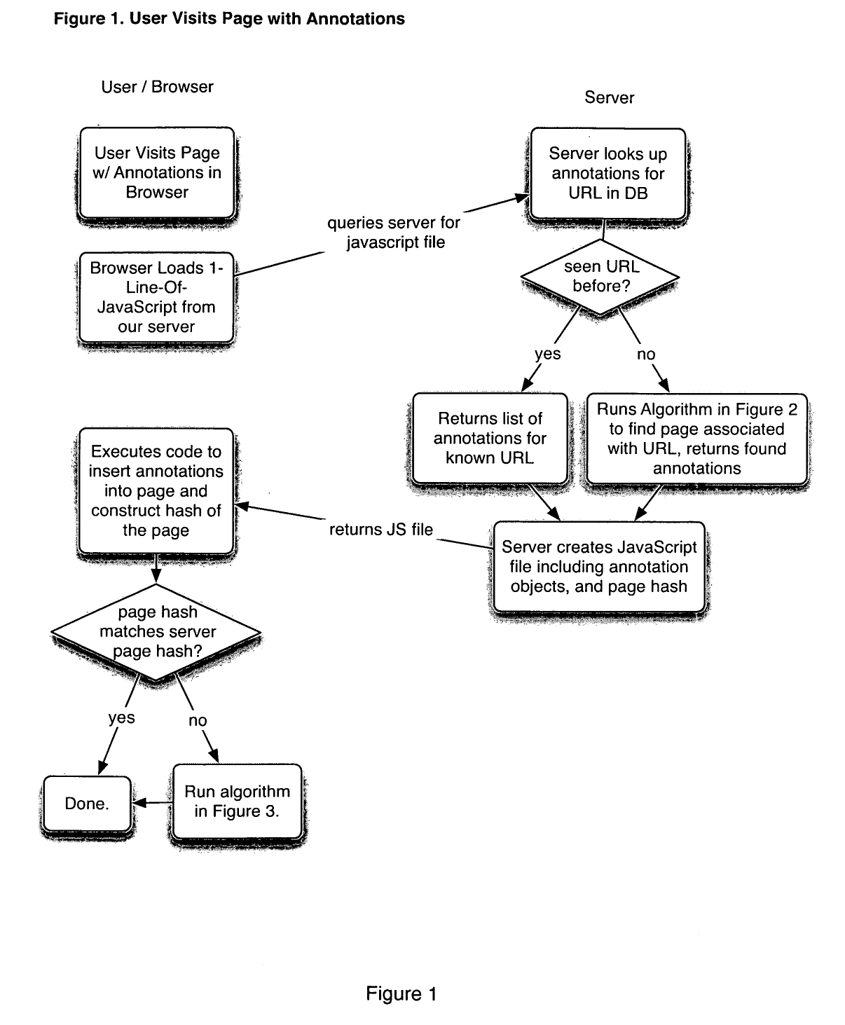

### Viewing Annotations (See FIG. 1)

When a visitor visits a page enabled by the editing system with their web browser, the following happens. Their browser renders the page and detects that there is one line of HTML that points to an external JavaScript file. It then requests this JavaScript file from the system web server. The JavaScript file is then dynamically generated by the system web server and filled in with the list of annotations for that page together with the code to insert them. However, since the line is identical on different pages, and does not identify the page that it was embedded into, the web server looks at the HTTP_REFERER header to infer where it was being requested from. Since web browsers sometimes do not set this header (e.g. because the user turned if off) we handle this specially and in that case send a simple JavaScript file which looks at the value of the browser's address bar and sends it to the system Server after which the main code continues. Using the URL of the page the server then looks up the annotations for that page in its database. If it has a record of the URL it loads the annotations from the database and returns them to the web browser together with the rest of system JavaScript. Otherwise it runs through the process further described below in Identifying Identical Pages with Different URLs.

Once the JavaScript has been returned to the browser the browser executes the Annotation Insertion Algorithm contained in the code. The algorithm visits a subset of nodes contained in the DOM, in the same order that the corresponding html elements appeared in the HTML source document (from beginning to end). Each visited node is visited exactly once, regardless of the number of dynamic elements that the algorithm is tasked with inserting into the document.

The algorithm determines the subset of nodes to visit by starting at a DOM element with a known identifier (or the beginning of the body of the document, if no such element is defined), and considering all nodes (of the type specified in the annotation list) in order until reaching a DOM element with another known identifier (or the end of the body of the document, if no such element is defined). These known identifiers allow page authors to limit the portion of a page into which annotations can be inserted.

In order to insert all annotations in a single pass through the document, the algorithm generates a single regular expression which will match any of the identifier strings for the annotations to be inserted. Since common HTML parsers have different rules for parsing whitespace characters in the source document text (e.g. spaces, tabs, linefeeds, and newlines), the regular expression allows any non-zero number of consecutive whitespace characters to match any whitespace characters within the text strings.

For each of the nodes visited in order, the regular expression described above is matched against the text of text nodes and the id, class, and/or src of certain other node types (e.g. table, span, image). If this regular expression matches at a given location, the algorithm then iterates through each of the identifier strings to determine whether that particular text string matches at that location. For each identifier string that matches, a corresponding dynamic element (representing an annotation) is created and inserted in a list of elements which will ultimately replace the original text node. After processing all dynamic elements at this location, the algorithm continues applying the regular expression to the remainder of the text node, repeatedly applying the same rules if another match is found.

Once the regular expression fails to find additional matches in a given node, if any matches were found, the algorithm replaces the original node in the DOM with the replacement DOM elements determined in the step above.

When the algorithm replaces an original DOM element with a new set of DOM elements, it saves the original DOM element in a data structure that makes it possible to restore the DOM to its original state, or to calculate occurrence indexes as they would have been before the DOM was altered.

Since the running time of the algorithm is generally proportional to the length of the document, and current scripting implementations in a web browser generally freeze the user interface while script code is executing, the algorithm periodically checks if a certain amount of time has elapsed while iterating over the content text nodes. If the elapsed amount of time has passed a fixed threshold, the algorithm returns control to the browser so that other user interaction can be processed and the browser does not appear unresponsive. Before returning control to the browser, the algorithm sets a timer which will restart the process of inserting annotations at the point where it left off.

Since the dynamic elements are positioned using identifier strings and occurrence indexes, changes in the underlying HTML source document can cause the algorithm to place dynamic elements in a different location in the text flow than they were originally intended. The algorithm detects many changes that would cause the dynamic elements to be inserted in a different location, which then notifies a separate server component to calculate new text strings and occurrence indexes as necessary. This is explained in more detail in ‘Updating Annotations’ below.

### Creating Annotations

Having described how existing annotations are inserted into a page when it is loaded we will now describe how these annotations are created in the first place. We will concentrate on the process of identifying where a user wanted to insert an annotation instead of the user interface for facilitating this process. An example user interfaces would allow the user to select text in the document and then bring up a panel with options for what kind of changes the user wants to make to that text as well as adding invisible buttons to parts of a page (e.g. images, tables, paragraphs) that appear when the user moves his mouse over them that bring up the same panel. We will begin our technical explanation with the example of adding annotations to text that the user has highlighted.

Retrieving the text from a web browser's selection is non-trivial. The system extracts the selected text from the selection in the following way. In Firefox and Safari, the selection object is obtained by calling window.getSelection in JavaScript which returns a DOM text node element and the character offset into the element's inner text to indicate the beginning of the selection. In Internet Explorer, the selection is obtained by calling document.selection.createRange which returns a Range object. Because a Range object is not capable of revealing the location of the DOM element containing the selection, instead we determine the start and end location of the selection by inserting a “dummy” DOM element into the DOM tree before and after the selection. Once the location to insert the annotation at has been identified we replace the original DOM element at that location with a new set of DOM elements (the annotation) while saving the original elements as described above.

Identifying the location of other elements on a page such as tables, images, and paragraphs is much simpler and works the same between different browsers. When a site visitor goes into edit mode (e.g. by clicking a bookmarklet in their browser or pushing a keyboard shortcut) the JavaScript code again cycles through a subset of DOM nodes which users can modify (e.g. Tables, Divs, Spans, Images, . . . ) and adds mouse over handles to them that call system-specific JavaScript. When the user then moves his mouse over one of these elements the appearance of this element changes to signal to the user that they can modify it (e.g. by displaying a mouse over button or changing the borders of that element and making it clickable). Since the mouse over handler is directly tied to the DOM element to be modified the code being run in the mouse over handler will know what element it is being called on and will replace this element with the new annotation DOM elements.

### Cross Domain Communication

As previously described, when reading existing data from the system web service, the pages on http://www.example.com/ communicate with http://www.apture.com/ by including a <script> tag on the page which causes the browser to perform a HTTP GET request to one of the system servers.

However, when adding a new annotation to a webpage, the user does not simply want to read existing data on the system servers, but store new data. In this case, the <script> tag approach described above is not sufficient, because <script> tags only allow GET requests, while HTTP operations that change state should use the POST method. Unlike GET requests, POST operations allow much more data to be uploaded from the client to the server; the responses will not be cached by intermediate HTTP proxies; and they prevent a user from inadvertently changing state simply by clicking a hyperlink.

However, the use of HTTP POST in the system is complicated by the security models of modern web browsers, which do not allow a page in one domain to retrieve the response of a POST request made to another domain. While it is possible for a web page at http://www.example.com to generate a POST request to http://www.apture.com by using a dynamically-created <iframe> tag, security restrictions in all modern browsers will prevent any code on the http://www.example.com page from accessing the response data from the <iframe>. Mirrored Page solutions do not face this restriction because they redisplay the page in question inside the solution providers domain (by proxying through their server); similarly, Browser Plugin solutions do not face this restriction because plugin code is subject to a different security model.

In order to communicate the response of a POST request in the http://www.apture.com domain back to a page in the http://www.example.com domain, the system uses an API provided by Adobe Flash. This requires that users editing system annotations have a Flash plugin installed in their browser. Flash provides an API, called LocalConnection, that allows multiple Flash objects on the same computer to communicate, regardless of where the Flash objects are embedded. Hence, webpages in different domains can communicate as follows:

1) Script running on a page in the http://www.example.com domain creates a Flash object (denoted F1) and creates a LocalConnection which passively listens for connections from other Flash objects.

2) Script running on a page in the http://www.apture.com domain creates a Flash object (denoted F2), passing in data to communicate via “FlashVars”, a standard way of providing variables to Flash objects at runtime.

3) Flash object F2 creates a LocalConnection to F1, and sends the data.

4) Flash object F1 sends the data to the script on the http://www.example.com webpage containing it by executing a call to the getURL( ) function with the “javascript:” pseudo-protocol.

5) The script on the http://www.example.com page handles the data.

In order for the two ends of the Flash channel to identify each other uniquely, a connection name which is likely to be unique is chosen before establishing the connection, and is provided to both Flash objects.

Since some browsers limit the length of “javascript:” pseudo-URLs, and often we wish to send larger amounts of data through the Flash channel, the system breaks up long messages into several chunks, each identified with a message identifier, a chunk index, and the number of chunks. In this case, each chunk is sent using a separate Flash object, while there is still only one Flash object which receives all chunks for the connection. The receiving script then collects and reassembles chunks of messages, and processes the data once all chunks with a given message identifier have been received.

Thus, in order for a user visiting a site on the http://www.example.com domain to change some state on the http://www.apture.com domain (such as by adding, modifying, or deleting an annotation), we employ the following steps to communicate data between the two domains:

1) Code running in the context of http://www.example.com opens an <iframe> in the http://www.apture.com domain, communicating any necessary data (e.g., the text that is to be linked) via query string parameters in the <iframe>'s URL.

2) The user interacts with the <iframe> in the http://www.apture.com, ultimately clicking a button to POST data to another URL in the http://www.apture.com domain.

3) The server handles the POST request by e.g. adding, modifying, or deleting the annotation.

4) The response to the POST request is another HTML page, which communicates the result of the operation back to the original page in the http://www.example.com domain, via the Flash communication channel described above.

5) Having retrieved the result of the operation, the http://www.example.com page closes the <iframe>.

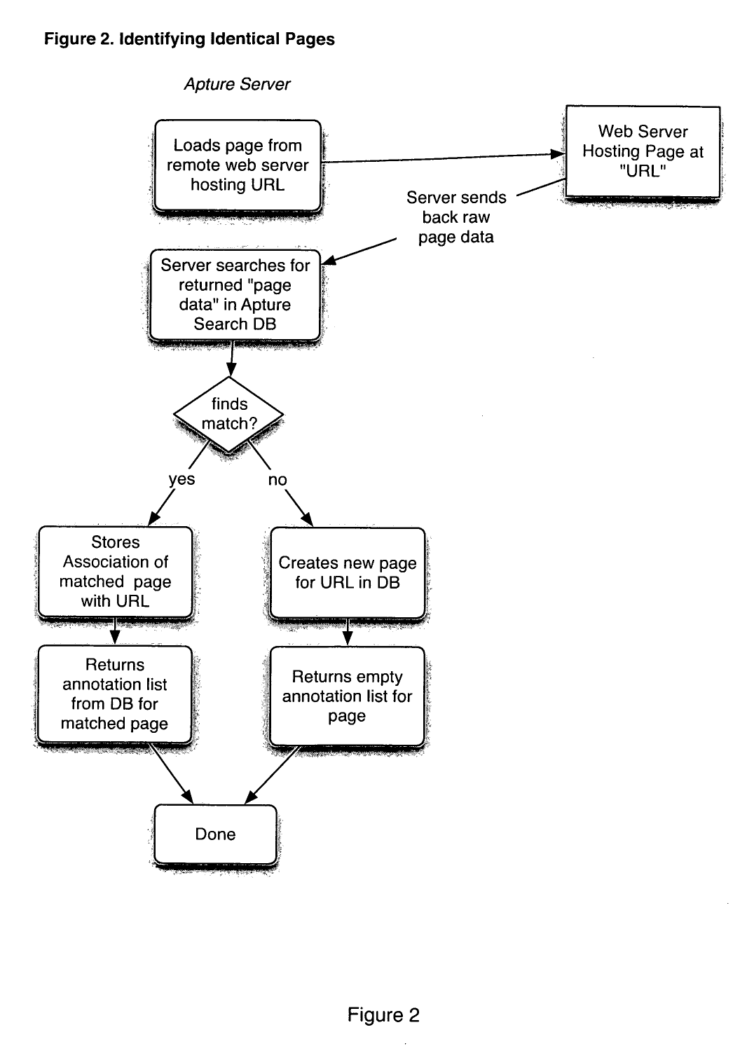

Identifying Identical Pages with Different URLs (See FIG. 2)

We described above how the URL of a page is used to lookup the annotations that have been placed on it. There are, however, oftentimes web pages that have multiple URLs pointing to them such as http://www.cnn.com/money/ and http://money.cnn.com/, if someone places system annotations on the former they should also appear on the later. In this example explanation we assume that http://www.cnn.com/money/ has been visited once before but that http://money.cnn.com/ has never been visited before. When a user visits http://money.cnn.com/ his browser will again execute the system JavaScript which will call the Server to retrieve the annotations for this page. The server will try to lookup http://money.cnn.com/ in its database but will not find an entry for the URL. It will then retrieve this URL from the CNN web server and then search its search index of webpages belonging to this particular Site registered by the system to see if it can find pages with similar content. An exact match of the page content is not required because web servers will sometimes return slightly different data for the same page such as different ad codes or different values for an embedded time of day. Because of this we cannot simply lookup a hash of the page content because it would miss lots of pages. Instead the matching is currently implemented by performing a search using the Open Source Sphinx Search Engine after stripping the page of a large list of stopwords and matching all documents that contain any of the words while sorting by relevancy. We then go through the candidate documents one by one until we find one that is sufficiently similar or determine that such a document does not exist otherwise. Since the candidate documents are sorted by similarity we only have to look at a few candidates. Once we have found a matching document we create a database entry for the new url and make it point to this existing page. From then on both URLs will map to the same identical page and all changes made to a page through one URL will be reflected through all the other URLs pointing to this page. If there is no matching page for the URL we create a new empty page record as described above.

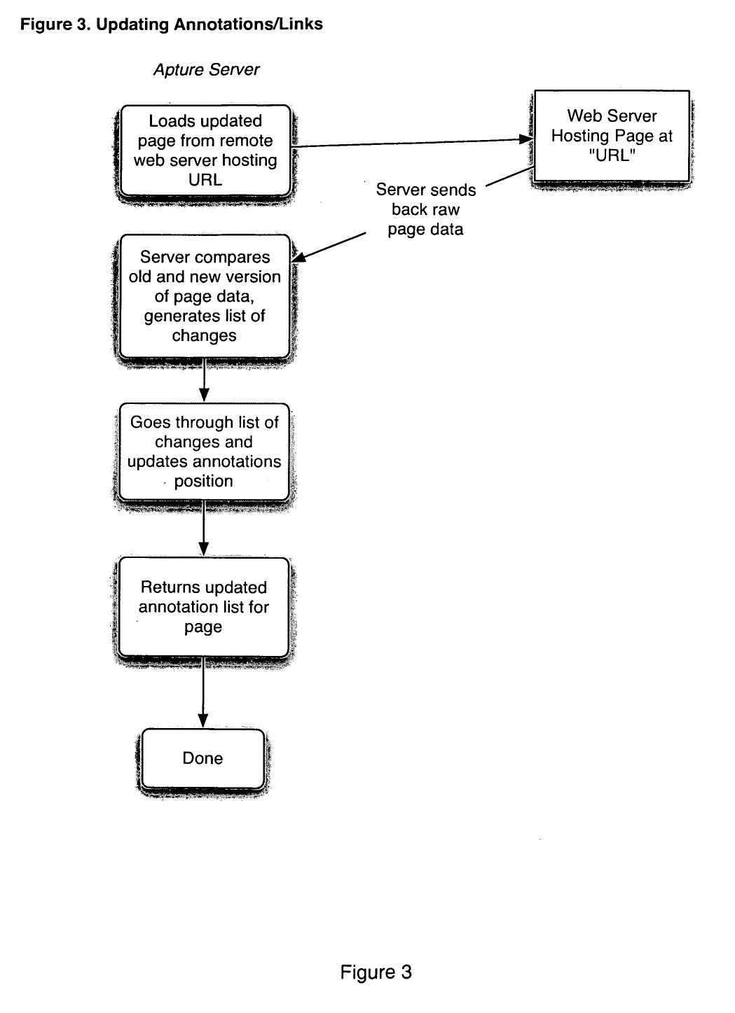

### Updating Annotations (See FIG. 3)

Since system annotations are not stored together with the actual page they appear on but are instead positioned on that page using an index into the content of that page we need to update them as the content of the page changes. Doing this requires being able to efficiently detect when a page has changed and then finding the new position of annotations on the page. To detect whether a page has changed we compute a hash (described below) that identifies the current state of the page which we then store in our database. When a user opens the page our JavaScript code is executed in the user's browser and will try to reinsert the system annotations into the page as described above. During this process it will also compute the hash of the page, which it will then compare to the stored copy of the hash which was sent by the web server together with the system annotations. If it finds that the hash no longer matches it will then contact the web server again using an AJAX call to request an updated copy of the page annotations.

When the web server receives the update request from the web browser it retrieves an updated version of the page from the web server that it is stored on (a CNN web server in our example). It then compares this copy to its own stored copy of the page and computes the changes between them. One simple way of doing this is by using the standard UNIX diff utility which returns the difference between two files. Our implementation uses the standard python difflib library but compares a list of words and HTML tags (split by whitespace, or the start of end of an HTML tag so that ‘<a><i>a b’ would be ‘<a>, <i>, a, b’) instead of lines because there might be several annotations per line. This returns a list of change entries with each entry specifying the start and end position of the changed text in both the old and the new version of the text and whether the change was a replacement, insertion, or deletion.

Our algorithm then iterates through all annotations on a page and for each annotation iterates through all the changes to the page.

If a change occurs before the identifier for a particular annotation and contains its identifier we increment or decrement the occurrence index by the number of times the identifying text occurs in the insertion. For example, inserting the text “The United States is a country” before the annotation with the identifier “country” would mean that the occurrence index of the annotation is incremented by 1. Deleting an occurrence decrements the index and replacing a section of text results in the net change (subtract the old occurrence count from the new one) being added to the index. If a change happens after an annotation it cannot have an effect on this annotation and is therefore ignored. Annotations that are fully or partially contained in a change are more complicated to resolve. For these we have to both update the actual identifying text and then recomputed the occurrence index based on this new text. End of paragraph notes are a good example, they use the last 30 characters of the preceding text node as their identifying text so that when this identifying text is part of a change we have to update the identifier by setting it to the last 30 characters of the now changed paragraph node. Since the identifying text has changed we now have to recompute the occurrence index for it as well.

Once this algorithm has iterated through all the annotations the update information is then sent back to the frontend which reruns its algorithm to insert the annotations and computes the new hash which it then sends back to the backend to store.

The critical reader might have noticed that a malicious client could continuously send the web server different hashes to cause it to continuously cause it to update a page and therefore run it out of resources. A client cannot, however, make annotations show up in an incorrect position or cause them to disappear because the hash that is sent by the frontend is only—a hint—the web server only fetches pages from the server they are hosted on and never allows the client's web browser to set the contents of the page. After fetching a page from the internet the server then checks whether the pages has actually changed (through a simple comparison) and skips the rest of the algorithm if this is not the case. It also queues link update requests and handles them asynchronously so that a malicious client can at worst slow down the updating of annotations but not affect the rest of the performance of the system. A number of measures can then be taken to minimize the impact of malicious clients. The first is to have separate queues for separate sites so that an attack on one site will only affect that site and not other ones using the system. The next is to also store the ip address of the client that made the update request in the queue and penalize clients that have been sending many update requests for a page, especially when there are no update requests from other clients that are visiting the page (these are likely to be spurious requests). Finally, an extreme solution of penalizing is also possible where update requests from particular clients are completely ignored when it is suspected that they are acting maliciously.

### Computing the Hash

The most obvious solution for computing a hash of a page would be to simply calculate a regular hash of the HTML of a page but there are several reasons this is not a feasible solution. The first is because it is simply impossible to access the actual source of the page from Javascript. The second is that a page might be superficially different depending on what URL it was reached from as described above. And the hash would change depending on what URL the page is accessed from. The third is that if we tried to compute the hash over the entire DOM it would be browser depending because of the differences in HTML rendering between browsers. Because of this we would like to have a Hash that will be the same between browsers and detect structural changes to the page or any other changes that might affect the placement of annotations but does not change when unrelated parts of the page change. The hash is calculated over the name and number of occurrences of each annotations anchor in the document, and the relative ordering between the different anchors when placed on the page.

Page1:

<a>test test</a> and <a>

### Account Management

Having described the other core parts of the invention let us return to the ability to support access controls for who is allowed to edit a page. A page that can be edited by anyone without any consideration of access control could be created by simply embedding the following line of HTML in a page ‘<script type=“text/javascript” src=“http://www.apture.com/js/apturejs”></script>’ without even registering with the system. Restricting access to specific users involves additional challenges that we describe below.

Implementing access control will mean that an editor has to create an account with the system, for instance by signing up for it on a website. In order to prove that their new account is associated with a particular website the editor needs to embed a unique identifier associated with this account (which is automatically generated for them by our system) into the page that the service is to be enabled on. This is necessary to prove that the person who created the account actually has the ability to edit the page and can therefore be trusted to edit it through the system (because this does not give them any additional privileges). For simplicity we make editors append this identifier to the end of the one line of HTML that they are placing onto the page e.g. ‘<script type=“text/javascript” src=“http://www.apture.com/js/apture.js?siteToken=xK4iwbVl2ifY”></script>’.

Once the editor has placed the identifier onto their pages they can then log into the Editing system and modify pages from within their web browser. Users can login to the system on a separate page on our server or right on their page in a special login panel in an IFrame. This panel can be set to display automatically when the page is loaded, or be tied to a keyboard shortcut (e.g. activated by pushing the ‘e’ button on the keyboard) or be displayed through a JavaScript bookmarklet.

Editors can also invite other people to edit these pages, provided that they also can identify themselves to the system (e.g. by signing up for an account or using a standard identification system) and can limit people's edit rights to particular URL prefixes so that one user would be allowed to edit http://www.blog.com/userA but not http://www.blog.com/userB. When the user tries to edit a particular page the system will check whether the page he is editing matches one of the URL Prefixes that he has editing rights on. This needs to be implemented carefully as it could otherwise give rise to the following security vulnerability:

A user with access to the /userB directory who is visiting a page in the /userA directory and trying to edit it could fake the HTTP_REFERER header to say that they are visiting from the /userB directory. If the access check was done in a separate step before actually opening the page the user could then make the system open the page in the /userA directory but have the security check applied to the page in the /userB directory and thereby circumvent the security check. Instead we first open the page and then perform the access check on the URL of that page, not a separate URL passed by the user. If the user fakes their REFERER as described above all his changes would be made in the /userB directory which he already has access to.

Finally, Account information, URL Prefixes and Permission Lists are all stored in a Relational Database. Each permission entry references a user account, a URL Prefix, and stores a permission that the user has for that Base URL (there can be several entries for each User/URL Prefix combination.

Although the present invention has been particularly described with reference to embodiments thereof, it should be readily apparent to those of ordinary skill in the art that various changes, modifications and substitutes are intended within the form and details thereof, without departing from the spirit and scope of the invention. Accordingly, it will be appreciated that in numerous instances some features of the invention will be employed without a corresponding use of other features. Further, those skilled in the art will understand that variations can be made in the number and arrangement of components illustrated in the above figures. It is intended that the scope of the appended claims include such changes and modifications.

What is claimed is:

1. A method of storing annotations for a web page that contains a script therein, which annotations in use are merged with the web page to present an annotated web page on a computer display, the method comprising the steps of:
receiving at an annotation server, at least one annotation for the web page, the annotation including content and a location of the content within the web page, wherein the content identifies a change to render to the web page to obtain the annotated web page and wherein the location is independent of a placement location of the script within the web page;
storing the at least one annotation in a memory location of the annotation server, the at least one annotation including reference to the web page;
receiving, at the annotation server, a request for the annotation based upon the script stored within the webpage; and
automatically transmitting, from the memory location, in response to the request, the annotation.

2. The method according to claim 1, wherein the step of receiving the at least one annotation includes receiving a POST request.

3. The method according to claim 2, wherein a domain of the annotation server is different than a domain on which the web page exists.

4. The method according to claim 1, further including the steps of:
detecting, at the annotation server, that a change has occurred to the web page, thus obtaining a changed web page;
determining, at the annotation server, a new location for the annotation based upon the changed web page; and
updating the at least one annotation stored in the memory location of the annotation server to obtain an updated annotation, the updated annotation including reference to the changed web page and the new location for the updated annotation within the changed web page.

5. The method according to claim 1 wherein the script is one line of HTML that is used to load JavaScript.

6. The method according to claim 1 wherein the location is referenced using a characteristic associated with a node of a Document Object Model tree.

7. The method according to claim 6 wherein an index is associated with the characteristic.

8. The method according to claim 1 further including the steps of:
recognizing, at the annotation server, a plurality of different web pages that each contain content that is substantially identical to that content of the web page; and
correlating, at the annotation server, the annotations for the web page to associate the annotations with each of the plurality of different web pages.

9. The method according to claim 1 wherein the steps of receiving and storing do not require a special tag in order to identify the annotation.

10. A method of displaying on a display an annotated web page, the annotated web page created from merging a web page that contains a script therein with an annotation, the method comprising the steps of:
receiving at a computer that includes a processor, a display memory, and executable software, the web page that contains the script therein;
detecting, using the processor and the executable software, the script;
transmitting, based upon the detected script, a request for the annotation;
receiving the annotation at the computer, the annotation including content and a location of the content within the web page, wherein the content identifies a change to render to the web page to obtain the annotated web page and wherein the location is independent of and different from a placement location of the script within the web page;
associating, using the processor and the application, the web page and the annotation to obtain the annotated webpage; and
transmitting data of the annotated web page for displaying on the display.

11. The method according to claim 10 wherein the step of receiving the annotation receives a plurality of annotations.

12. The method according to claim 11 wherein the plurality of annotations includes all annotations associated with the annotated web page, and only annotations associated with the annotated web page.

13. The method according to claim 10, wherein a domain included in the request for the annotation is different than another domain that is identified in the web page associated with the step of receiving the web page that contains the script therein.

14. The method according to claim 10 wherein the script is one line of HTML that is used to load JavaScript.

15. The method according to claim 10 wherein the location is referenced using a characteristic associated with a node of a Document Object Model tree.

16. The method according to claim 15 wherein an index is associated with the characteristic.

17. The method according to claim 10, wherein a domain of the web page can be one of a plurality of different domains, such that the steps of receiving the web page, detecting the script, transmitting the request for annotation, receiving the annotation, associating, and transmitting the data are all performed independent of which one of the plurality of domains is the domain.

18. A computer-readable medium storing a program for generating an annotated web page, said program causing a computer to perform:
input of the web page that contains the script therein;
detecting of the script within the web page;
transmitting, based upon the detected script, a request for the annotation;
input of the annotation, the annotation including content and a location of the content within the web page, wherein the content identifies a change to render to the web page to obtain the annotated web page and wherein the location is independent of and different from a placement location of the script within the web page;
associating the web page and the annotation to obtain the annotated webpage; and
transmitting data of the annotated web page for display.
